(19) United States
(12) Patent Application Publication
(10) Pub. No.: US 2010/0291409 A1
(43) Pub. Date: Nov. 18, 2010

(54) Method for making a photoluminescent article

(75) Inventors: David B. Dicks, Charlotte, NC (US); Pieter W. Grobbelaar, Charlotte, NC (US)

Correspondence Address: RALPH H. DOUGHERTY, 4219 KRONOS PLACE, CHARLOTTE, NC, 28210, US

(73) Assignee: NATGLOW USA, INC.

(21) Appl. No.: 12/800,457

(22) Filed: May 14, 2010

Related U.S. Application Data
(60) Provisional application No. 61/216,600, filed on May 18, 2009.

(51) Int. Cl. C09K 11/08; C09K 11/02; C09K 11/56; B32B 9/00

(52) U.S. Cl. 428/690; 252/301.36; 252/301.4 R; 252/301.6 S

(57) ABSTRACT

A method for making products that glow in the dark, i.e., photoluminescent products, by coating such products with a photoluminescent pigment or ink, or with a plastic material containing the desired photoluminescent compound. Articles which are principally plastic, or having a plastic or partially plastic outer shell or covering can incorporate the photoluminescent pigment or ink directly within the plastic material itself. Photoluminescent products are also disclosed, which may also incorporate reflective material.

### CROSS REFERENCE TO RELATED APPLICATION

This application claims the benefit of U.S. Provisional Application No. 61/216,600, filed May 18, 2009.

### FIELD OF THE INVENTION

The present invention relates to products that glow in the dark, that is, they are capable of absorbing light and then emitting light. This is accomplished by providing specific products with a photoluminescent coating, or if the product is plastic, by incorporating the photoluminescent pigment into the plastic itself.

### DESCRIPTION OF THE PRIOR ART

Applicants are aware of the following United States patent concerning phosphorescent materials:

| US Pat. No. | Inventor | Title |
|---|---|---|
| 5,424,006 | Murayama | PHOSPHORESCENT PHOSPHOR |

### SUMMARY OF THE INVENTION

The invention provides a method for making products that glow in the dark, i.e., photoluminescent products, by coating such products with a photoluminescent pigment or ink, or with a plastic material containing the desired photoluminescent compound. Articles which are principally plastic, or having a plastic or partially plastic outer shell or covering can incorporate the photoluminescent pigment or ink directly within the plastic material itself.

### OBJECTS OF THE INVENTION

The principal object of the invention is to provide an improved method of producing photoluminescent products for industrial, commercial, governmental, and personal use.

It is also an object of this invention to provide an article of manufacture which will emit light from phosphorescent or photoluminescent pigment coated thereon or contained therein.

It is also an object of this invention to provide an article of manufacture which will both reflect light and emit light from phosphorescent or photoluminescent pigment coated thereon or contained therein.

It is another object of the invention to provide a better measure of safety for many articles of manufacture than are heretofore available

It is another object of this invention to provide additional safety items for homes, hospitals, schools, government buildings, and all commercial buildings, sports venues, and all modes of transportation.

### DETAILED DESCRIPTION

The invented process consists of mixing from 1 to 30 percent of a photoluminescent compound into 70 to 99 percent of a carrier, such as a plastic material, ink, paint or paint base, and coating all or a suitable or desired portion of any desired product with the resulting mixture to form a photoluminescent product. A preferred range is 5 to 20 percent of a photoluminescent compound mixed into 80 to 95 percent of the carrier.

Suitable photoluminescent materials include a strontium, europium, aluminum, and boron oxide composition having the chemical formula

mSr₁₋ₓEuₓO.nAl₂O₃.yB₂O₃,

with the ranges of coefficients: 1≦m≦5, 1≦n≦8, 0.001≦x≦0.1, 0.005≦y≦0.35;

Other suitable photoluminescent materials have the formulae:

mSr_{0.97}Eu_{0.03}O.Al₂O₃.0.01B₂O₃

where m is from 1 to 5; or

ZnS:Cu or (ZnCd)S:Cu

The afterglow of these photoluminescent materials are stable in performance and have a long after-glow time after exposure to ultraviolet or natural light; normally, a few minutes' of exposure to natural light can create an after-glow time of 6 to 10 hours, and sometime more than 10 hours.

In accordance with the invention, roofing material is made by mixing photoluminous pigment into a resin, then injection molding the mixture into the desired form, or the roofing material can be made by a vacuum forming process with the photoluminous pigment mixed into the resin. The invented process is especially well suited to small roofs, specifically the Port-a-Jon type of roofs, and box truck and trailer roofs.

The invented process includes mixing the photoluminous pigment into a resin of any kind and then producing any kind of roof material or roof coating.

The coating, painting or covering of light reflectors is accomplished by a powder coating process, painting process or by covering the reflector with glow in the dark coverings (vinyl, plastic, metal, etc.), with photoluminous pigment mixed into the powder coating, the paint, or integrated into a film of any desired kind to cover the reflector of any type of light to cause it to glow in the dark.

For a canvas, photoluminous pigment may be integrated into the canvas material itself. This is particularly well suited to tents, tarpaulins, and truck covers.

Traffic cones can be made of plastics with photoluminescent pigment incorporated therein, or can be painted with photoluminescent paint, or can be provided with a photoluminescent cover, any of which will be recharged by the lights of passing traffic. Further, the traffic cone can be provided with reflective beads, such as are available from Ames Research Laboratories, Inc., of Jefferson, Oreg., which will make the cones more prominent to passing traffic at night. Preferably, this reflective photoluminescent product is made by mixing from about 5 to about 25 percent by weight of reflective beads with about 5 to about 25 percent of photoluminescent pigment with the balance being a paint base.

Firefighting equipment can be provided with photoluminescent surfaces. Of particular importance are fire extinguishers, firemen's hard hats, axe handles, and hose nozzles, and even fire hydrants, both indoors and outdoors. Fire hydrants can also be provided with reflective beads in the same manner as traffic cones, as described above.

For ease of location in an emergency, fire extinguisher holders, including fire extinguisher cabinets can be provided with photoluminescent surfaces. On a boat, fire extinguisher holders are normally at or near the exterior of the boat, where sunlight or incidental daylight will recharge the photoluminescent surfaces.

Boating equipment can advantageously be provided with photoluminescent surfaces, such as boat fenders, bumpers, bumper rails, or rub rails, and sleeves for various lines on a boat. Sleeves can be wrapped about a line, such as a rope or cable stay for a mast. Such sleeve can be photoluminescent plastic or tape, which can be wound around the line, or the sleeve can be tubular, preferably with a longitudinal slot therein to allow the sleeve to be easily and removably affixed to the rope or cable. These products can also be provided with reflective beads, in the same manner as traffic cones, described above.

Lifeboats and life rafts are advantageously provided with photoluminescent surfaces, or a combination of reflective and photoluminescent surfaces, which allow ease of locating during an emergency, both by departing passengers before and after launching, and by rescuers. This will enable more effective sea searches, since the glow will be enhanced by a searchlight when searching at night, even if the searchlight beam does not impinge directly on the life boat or life raft. Life jackets are also advantageously provided with photoluminescent surfaces, or a combination of reflective and photoluminescent surfaces, both for ease of locating before abandoning ship, and for ease of location by rescuers.

To aid in a sea rescue, the invention also provides lightweight plastic beads having a specific gravity lighter than water, so that they will float, the beads incorporating the disclosed photoluminescent material therein. The beads may be conveniently provided in a pouch which may itself be covered by or made from a photoluminescent material. In use, they are spread on the water around a lifeboat or a person in the water to provide a greater presence of material to aid in rescue.

Evacuation plaques showing evacuation routes and identifying exits may be printed on photoluminescent paper, or with photoluminescent ink. Such plaques are especially suitable for all types of buildings and structures, including, without limitation, hotels, apartment buildings, office buildings, and other commercial buildings, public buildings such as schools, governmental and military buildings, civic buildings, sports venues, underground structures, such as subways, train stations, and the like. They are also useful in ships, including cargo ships, cruise ships and passenger liners, and military ships of all types, including submarines and surface vessels.

Tape having a photoluminescent surface is useful in many places to provide indicators of location and direction. Such tape is normally plastic with photoluminescent pigment incorporated therein, as described above. They may include reflective beads thereon, if desired for a particular application. Such tape may be provided on clothing, such as firemen's jackets, life jackets, or for wear at night, to identify or indicate the location of a person.

Photoluminescent paints having reflective beads incorporated therein are particularly useful for marking roads, both centerlines and road edges, for road signs, including traffic signs and warning signs, and for house and building numbers. They are also useful for marking the shafts or fletching of arrows for easy location and retrieval by archers.

Other photoluminescent products which are included, without limitation, within the scope of this invention are:

cover or sleeve for a flashlight;

roofing material, roof panels, and manufactured roofs;

truck interiors;

mud flaps;

canvas coverings;

rest room interiors;

portable toilet interiors, such as “porta-johns”;

non-slip rubber or plastic mats;

stair treads;

ladders or parts thereof;

hand railings;

climbing handles and gripping handles, such as on trucks and railroad cars;

walkers for elderly and handicapped persons;

ceiling light reflectors;

inks;

ballards or posts;

buoys;

boat fenders, bumpers, bumper rails, or rub rails;

sleeves for various lines on a boat;

boat docks, or portions thereof, preferably edges against which a boat would rub or collide;

boat fishing floats, fishing lures and night fishing equipment.

sleeves or tubes for covering any elongated material such as ropes or cables, rods, or traffic batons, which one might desire to see in the dark;

glow pebbles or rocks made of plastic for decorating gardens and ponds;

animal identification tags.

Each of the foregoing may include reflective beads thereon or therein to enhance their reflectivity, as desired, in the same manner as described for traffic cones, above.

In those products that are made of plastic, or have a plastic outer surface, the pigment is incorporated into a plastic selected from the group consisting of: polypropylene, polyvinyl chloride, chlorinated polyvinyl chloride, polyvinylidene fluoride, vinyl esters, epoxy resins, polyethylene, ultra high molecular weight polyethylene, ethylene chlorotrifluoroethylene, ethylene tetrafluoroethylene, chlorortrifluoroethylene, fluorinated ethylene propylene, perfluoroalkoxy, acrylonitrile-butadiene-styrene, polyphenylene sulfide, polyphthalamide, fiberglass reinforced polyvinylchloride, polysulfone, thermoplastic and thermosetting plastic.

### SUMMARY OF THE ACHIEVEMENT OF THE OBJECTS OF THE INVENTION

From the foregoing, it is readily apparent that we have invented an improved method for producing photoluminescent products for industrial, commercial and personal use, as well as a series of articles of manufacture which will emit light from photoluminescent pigment coated thereon or contained therein, and in many instances having reflective beads incorporated therein, whereby the invention provides a better measure of safety for many articles of manufacture than is heretofore available

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A method for making a photoluminescent article comprising:
mixing from 1 to 30 percent by weight of photoluminescent pigment with 70 to 99 percent of a carrier, and coating the article or a portion thereof with said pigment.

2. A method according to claim 1 wherein the pigment is selected from the group having one of the following formulae:
mSr₁₋ₓEuₓO.nAl₂O₃.yB₂O₃,
where the ranges of coefficients are: 1≦m≦5, 1≦n≦8, 0.001≦x≦0.1, 0.005≦y≦0.35;
mSr_{0.97}Eu_{0.03}O.Al₂O₃.0.01B₂O₃;
ZnS:Cu; or
(ZnCd)S:Cu.

3. A method according to claim 1 wherein from 5 to 20 percent by weight of photoluminescent pigment is mixed with 80 to 95 percent of a carrier.

4. A method according to claim 1, wherein the carrier is selected from the group comprising ink, paint or paint base, and plastics.

5. A method for making a photoluminescent product comprising:
mixing from 1 to 30 percent by weight of photoluminescent pigment with 70 to 99 percent of a carrier, and coating the product or a portion thereof with said pigment.

6. A method according to claim 5 wherein from 5 to 20 percent by weight of photoluminescent pigment is mixed with 80 to 95 percent of the carrier.

7. An article of manufacture made by the method of claim 5, wherein the product is selected from the group consisting of:
cover or sleeve for a flashlight;
traffic cones or covers for traffic cones;
tapes;
emergency lighting;
roofing material, roof panels, and manufactured roofs;
truck covers;
truck interiors;
mud flaps;
canvas coverings;
rest room interiors;
portable toilet interiors, such as “porta-johns”;
non-slip rubber or plastic mats;
stair treads;
ladders or parts thereof;
hand railings;
climbing handles and gripping handles, such as on trucks and railroad cars;
walkers for elderly and handicapped persons;
light reflectors, including ceiling light reflectors;
floor tiles;
inks;
ballards or posts;
buoys;
boat fenders, bumpers, bumper rails, or rub rails;
sleeves for various lines on a boat;
boat docks, or portions thereof, dock edges against which a boat would rub or collide;
lifeboats and life rafts;
boat fishing floats, fishing lures and night fishing equipment.
sleeves or tubes for covering any elongated material, including ropes or cables, rods, or traffic batons, which one might desire to see in the dark;
evacuation plaques;
fire extinguishers and holders;
hats, including hard hats and firemen's hats;
fire axes;
fire hose nozzles;
fire hydrants;
glow pebbles or rocks made of plastic for decorating gardens and ponds;
animal identification tags;
vehicle markers, for bicycles, trains, aircraft, and motor vehicles;
road markings, road signs, traffic signs and warning signs;
house and building numbers;
shafts or fletching of arrows for archers;
tarpaulins;
tents; and
canvas.

8. A method for making a photoluminescent product comprising:
mixing from 1 to 30 percent by weight of photoluminescent pigment with 70 to 99 percent of a plastic carrier, which plastic forms all or a substantial portion of the product.

9. A method according to claim 8 wherein from 5 to 20 percent by weight of photoluminescent pigment is mixed with 80 to 95 percent of carrier.

10. A method according to claim 8 wherein the pigment is incorporated into a plastic carrier selected from the group consisting of: polypropylene, polyvinyl chloride, chlorinated polyvinyl chloride, polyvinylidene fluoride, vinyl esters, epoxy resins, polyethylene, ultra high molecular weight polyethylene, ethylene chlorotrifluoroethylene, ethylene tetrafluoroethylene, chlorortrifluoroethylene, fluorinated ethylene propylene, perfluoroalkoxy, acrylonitrile-butadiene-styrene, polyphenylene sulfide, polyphthalamide, fiberglass reinforced polyvinylchloride, polysulfone, thermoplastic and thermosetting plastic.

11. A method for making a photoluminescent plastic product, comprising:
mixing from about 5 to about 25 percent of reflective beads with about 75 to about 95 percent of the product of claim 8.

12. An article of manufacture made by the method of claim 8, wherein the article is selected from the group consisting of:
traffic cones or covers for traffic cones;
tapes;
emergency lighting;
roofing material, roof panels, and manufactured roofs;
truck interiors;
mud flaps;
rest room interiors;
portable toilet interiors, such as “porta-johns”;
non-slip plastic mats;
stair treads;
ladders or parts thereof;
hand railings;
climbing handles and gripping handles, such as on trucks and railroad cars;
walkers for elderly and handicapped persons;
light reflectors;
floor tiles;
ballards or posts;
buoys;
boat fenders, bumpers, bumper rails, or rub rails;
sleeves for various lines on a boat;
boat docks, or portions thereof, preferably edges against which a boat would rub or collide;
boat fishing floats, fishing lures and night fishing equipment.
sleeves or tubes for covering any elongated material such as ropes or cables, rods, or traffic batons, which one might desire to see in the dark;
lifeboats and life rafts;
lightweight plastic beads having a specific gravity lighter than water,
fire extinguishers and holders;
hats, including hard hats and firemen's hats;
fire axes;
fire hose nozzles;
glow pebbles or rocks made of plastic for decorating gardens and ponds;
animal identification tags;
vehicle markers, for bicycles, trains, aircraft, and motor vehicles;
road markings, road signs, traffic signs and warning signs;
house and building numbers;
shafts or fletching of arrows for archers;
tarpaulins;
tents; and
canvas.

13. A method of making a reflective photoluminescent product, comprising:
mixing from about 5 to about 25 percent of reflective beads with about 5 to about 25 percent of photoluminescent pigment with the balance being paint base; and
coating the product with the resulting mixture.

14. A method according to claim 13 wherein the pigment is selected from the group having one of the following formulae:
mSr₁₋ₓEuₓO.nAl₂O₃.yB₂O₃,
where the ranges of coefficients are: 1≦m≦5, 1≦n≦8, 0.001≦x≦0.1, 0.005≦y≦0.35;
mSr_{0.97}Eu_{0.03}O.Al₂O₃.0.01B₂O₃;
ZnS:Cu; or
(ZnCd)S:Cu.

15. An article of manufacture made by the method of claim 13, wherein the article is selected from the group consisting of:
cover or sleeve for a flashlight;
traffic cones or covers for traffic cones;
tapes;
emergency lighting;
roofing material, roof panels, and manufactured roofs;
truck covers;
truck interiors;
mud flaps;
canvas coverings;
rest room interiors;
portable toilet interiors, such as “porta-johns”;
non-slip rubber or plastic mats;
stair treads;
ladders or parts thereof;
hand railings;
climbing handles and gripping handles, such as on trucks and railroad cars;
walkers for elderly and handicapped persons;
light reflectors, including ceiling light reflectors;
floor tiles;
inks;
ballards or posts;
buoys;
boat fenders, bumpers, bumper rails, or rub rails;
sleeves for various lines on a boat;
boat docks, or portions thereof, preferably edges against which a boat would rub or collide;
boat fishing floats, fishing lures and night fishing equipment.
sleeves or tubes for covering any elongated material such as ropes or cables, rods, or traffic batons, which one might desire to see in the dark;
lifeboats and life rafts;
evacuation plaques;
fire extinguishers and holders;
hats, including hard hats and firemen's hats;
fire axes;
fire hose nozzles;
fire hydrants;
glow pebbles or rocks made of plastic for decorating gardens and ponds;
animal identification tags;
vehicle markers, for bicycles, trains, aircraft, and motor vehicles;
road markings, road signs, traffic signs and warning signs;
house and building numbers;
shafts or fletching of arrows for archers;
tarpaulins;
tents; and
canvas.

16. A method for making a photoluminescent ink, comprising
mixing from 1 to 30 percent by weight of photoluminescent pigment with 70 to 99 percent of an ink carrier.

17. A method according to claim 16 wherein from 5 to 20 percent by weight of photoluminescent pigment is mixed with 80 to 95 percent of the carrier.

18. A method according to claim 17 wherein the pigment is selected from the group having one of the following formulae:
mSr₁₋ₓEuₓO.nAl₂O₃.yB₂O₃,
where the ranges of coefficients are: 1≦m≦5, 1≦n≦8, 0.001≦x≦0.1, 0.005≦y≦0.35;
mSr_{0.97}Eu_{0.03}O.Al₂O₃.0.01B₂O₃;
ZnS:Cu; or
(ZnCd)S:Cu.

19. A method for making a photoluminescent paint, comprising
mixing from 1 to 30 percent by weight of photoluminescent pigment with 70 to 99 percent of a paint base carrier.

20. A method according to claim 19 wherein from 5 to 20 percent by weight of photoluminescent pigment is mixed with 80 to 95 percent of paint base.

21. A method according to claim 20 wherein the pigment is selected from the group having one of the following formulae:
mSr₁₋ₓEuₓO.nAl₂O₃.yB₂O₃,
where the ranges of coefficients are: 1≦m≦5, 1≦n≦8, 0.001≦x≦0.1, 0.005≦y≦0.35;
mSr_{0.97}Eu_{0.03}O.Al₂O₃.0.01B₂O₃;
ZnS:Cu; or
(ZnCd)S:Cu.
